(19) United States
(12) Patent Application Publication
(10) Pub. No.: US 2021/0083330 A1
(43) Pub. Date: Mar. 18, 2021

(54) POWER SUPPLY MANAGEMENT SYSTEM, BATTERY, CHARGER, AND UNMANNED AERIAL VEHICLE

(71) Applicant: SZ DJI TECHNOLOGY CO., LTD., Shenzhen (CN)

(72) Inventors: Liang LIANG, Shenzhen (CN); Deqiang MENG, Shenzhen (CN)

(21) Appl. No.: 17/105,974

(22) Filed: Nov. 27, 2020

Related U.S. Application Data
(63) Continuation of application No. PCT/CN2018/089220, filed on May 31, 2018.

(51) Int. Cl. H01M 10/42; H02J 7/00; H01M 10/48; B64C 39/02; B60L 50/60; B60L 58/10

(52) U.S. Cl. CPC H01M 10/425; H02J 7/00032; H02J 7/0047; H01M 10/486; B64C 39/024; B60L 2200/10; B60L 58/10; H01M 2010/4278; H01M 2010/4271; H01M 2220/20; B64C 2201/042; B60L 50/60

(57) ABSTRACT

A power supply management system includes a selection control circuit, a controller, and a communication cable. The controller is connected to the selection control circuit and configured to control the selection control circuit to switch between a temperature measurement mode and an encryption certification mode. One end of the communication cable is configured to be communicatively connected to a battery, and another end of the communication cable is electrically connected to a communication interface and a temperature measurement interface of the controller. When the selection control circuit switches to the temperature measurement mode, the controller is further configured to read a voltage of a temperature measurement resistor of the battery via the communication cable. When the selection control circuit switches to the encryption certification mode, the controller is further configured to communicate with an encryption chip of the battery via the communication cable.

### CROSS-REFERENCE TO RELATED APPLICATION

This application is a continuation of International Application No. PCT/CN2018/089220, filed May 31, 2018, the entire content of which is incorporated herein by reference.

### TECHNICAL FIELD

The present disclosure generally relates to the power supply control field and, more particularly, to a power supply management system, a battery, a charger, and an unmanned aerial vehicle (UAV).

### BACKGROUND

With the development of scientific technology and economy, mobile electronic device has been more and more applied in people's daily life and industrial manufacturing. The mobile electronic device is usually provided with a battery, thus the battery may provide power to the electronic device. However, since batteries with a variety of specifications and styles exist on the market, if an unsuitable battery is installed at the mobile electronic device, or the unsuitable battery is charged by a charger, damage may be easily caused to the mobile electronic device or the charger. Therefore, an encryption chip is built into the battery, and a power supply management system of the mobile electronic device or the charger communicates with the encryption chip to determine whether a current battery is a certified and acceptable battery.

Further, since the battery needs to work in a temperature range, both a temperature that is too low or too high will affect use lifetime of the battery and even cause the battery to explode. Therefore, a temperature measurement resistor is installed in the battery such that the power supply management system can further read a voltage of the temperature measurement resistor to monitor the temperature inside the battery. In the existing technology, the power supply management system needs to be connected to the encryption chip of the battery and the temperature measurement resistor via two cables to communication with the encryption chip via one of the cables and read the voltage of the temperature measurement resistor via the other cable. However, in this case, different pins need to be arranged at the battery for the encryption chip to be connected to a communication interface of the power supply management system and for the temperature measurement resistor to be connected to a temperature measurement interface of the power supply management system, respectively. Thus, components of the battery are too many, and the volume of the battery is large.

### SUMMARY

Embodiments of the present disclosure provide a power supply management system including a selection control circuit, a controller, and a communication cable. The controller is connected to the selection control circuit and configured to control the selection control circuit to switch between a temperature measurement mode and an encryption certification mode. One end of the communication cable is configured to be communicatively connected to a battery, and another end of the communication cable is electrically connected to a communication interface and a temperature measurement interface of the controller. When the selection control circuit switches to the temperature measurement mode, the controller is further configured to read a voltage of a temperature measurement resistor of the battery via the communication cable. When the selection control circuit switches to the encryption certification mode, the controller is further configured to communicate with an encryption chip of the battery via the communication cable.

Embodiments of the present disclosure provide an unmanned aerial vehicle (UAV) including an onboard controller and a power supply management system. The power supply management system includes a selection control circuit, a controller, and a communication cable. The controller is connected to the selection control circuit and configured to control the selection control circuit to switch between a temperature measurement mode and an encryption certification mode. One end of the communication cable is configured to be communicatively connected to a battery, and another end of the communication cable is electrically connected to a communication interface and a temperature measurement interface of the controller. When the selection control circuit switches to the temperature measurement mode, the controller is configured to read a voltage of a temperature measurement resistor of the battery via the communication cable. When the selection control circuit switches to the encryption certification mode, the controller is configured to communicate with an encryption chip of the battery via the communication cable.

### BRIEF DESCRIPTION OF THE DRAWINGS

FIG. 1 is a schematic circuit connection diagram of a power supply management system and a battery according to some embodiments of the present disclosure.

FIG. 2 is a schematic diagram of a selection control circuit according to some embodiments of the present disclosure.

FIG. 3 is a schematic diagram of another selection control circuit according to some embodiments of the present disclosure.

FIG. 4 is a schematic circuit diagram when a charger is used to charge an external battery according to some embodiments of the present disclosure.

FIG. 5 is a schematic circuit diagram of an unmanned aerial vehicle (UAV) and its onboard battery according to some embodiments of the present disclosure.

Reference numerals:

| | | | |
|---|---|---|---|
| 101 | Power supply management system | 1011 | Controller |
| 1015 | Communication cable | 103 | Charging circuit |
| 30 | Battery | 301 | Encryption chip |
| 11 | Charger | 111 | Charing circuit |
| 31 | External battery | 50 | Electrical grid |
| 13 | Unmanned aerial vehicle (UAV) | 131 | Onboard controller |
| 33 | Onboard battery | | |

### DETAILED DESCRIPTION OF THE EMBODIMENTS

In connection with accompanying drawings, some embodiments of the present disclosure are described in detail. With no conflict, features of embodiments may be combined with each other.

In the present disclosure, the terms “first” and “second” are only used for descriptive purposes, and cannot be understood as indicating or implying relative importance or implicitly indicating the number of indicated technical features. Therefore, the features defined with “first” and “second” may explicitly or implicitly include at least one of the features. In the description of the present disclosure, “a plurality of” means at least two, such as two, three, etc., unless otherwise specified.

In the description of this specification, descriptions of the terms “one embodiment,” “some embodiments,” “examples,” “specific examples,” or “some examples,” etc., mean that specific features, structures, materials, or characteristics described in connection with embodiments or examples are included in at least one embodiment or example of the present disclosure. In this specification, the schematic representations of the above-mentioned terms do not necessarily refer to same embodiments or examples. Moreover, the described specific features, structures, materials, or characteristics may be combined in any one or more embodiments or examples in an appropriate manner. In addition, with no conflict, those skilled in the art can combine and group different embodiments or examples and the features of different embodiments or examples described in this specification.

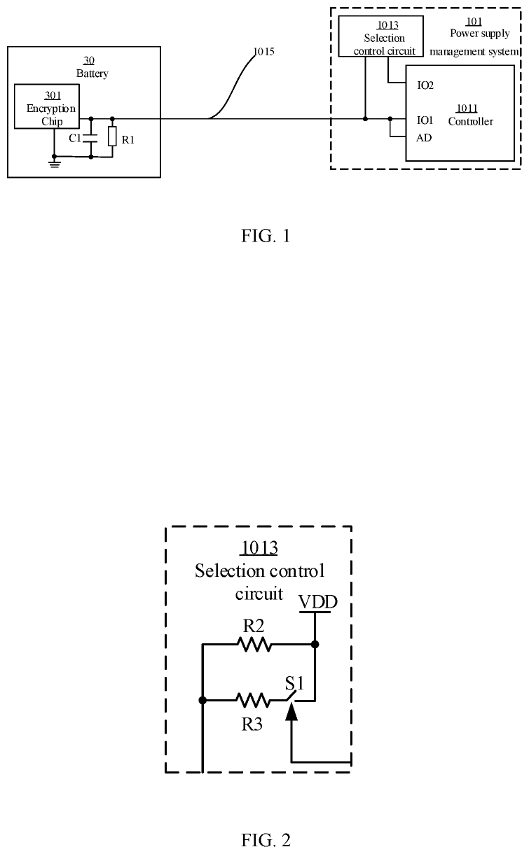

FIG. 1 is a schematic circuit connection diagram of a power supply management system 101 and a battery 30 according to some embodiments of the present disclosure. As shown in FIG. 1, the power supply management system 101 provided by embodiments of the present disclosure includes a single communication cable 1015, a controller 1011, and a selection control circuit 1013. An end of the communication cable 1015 is communicatively connected to the battery 30. The other end of the communication cable 1015 is electrically connected to a communication interface IO1 and a temperature measurement interface AD. The controller 1011 is further electrically connected to the selection control circuit 1013 to control the selection control circuit 1013 to switch between a temperature measurement mode and an encryption certification mode. When the controller 1011 controls the selection control circuit 1013 to switch to the temperature measurement mode, the controller 1011 may read a voltage of a temperature measurement resistor R1 of the battery 30 to obtain an inner temperature of the battery 30. When the controller 1011 controls the selection control circuit 1013 to switch to the encryption certification mode, the controller 1011 may communicate with an encryption chip 301 of the battery 30 via the communication cable 1015 to determine whether the battery 30 is a certified battery 30.

In some embodiments, the controller 1011 may include any suitable electronic components, such as an integrated circuit, a microcontroller unit (MCU), a microprocessor unit (MPU), etc. For example, the technical solution of embodiments of the present disclosure is described below when the controller 1011 includes the MCU. The other electronic components, such as the integrated circuit or the MPU may replace the MCU after simple modification, and these replacements are still within the scope of embodiments of the present disclosure.

The communication interface IO1 and the temperature measurement interface AD arranged at the MCU are electrically connected to an end of the communication cable 1015 to read the inner temperature of the battery 30 and communicate with the encryption chip 301 of the battery 30 at the other end of the communication cable 1015 via the communication cable 1015. In some examples, the communication interface IO1 and the temperature measurement interface AD connected to the communication cable 1015 may be integrated into one interface at the MCU. As such, wiring complexity inside the power supply management system 101 may be further reduced, and the MCU may be connected to more elements to realize more functions.

The MCU may further be electrically connected to a signal input terminal of the selection control circuit 1013 by arranging a control signal output interface IO2 at the MCU. As such, the MCU may output a control signal (e.g., a high-level signal, a low-level signal, or another electrical signal) to the selection control circuit 1013 through the control signal output interface 102. The control signal output to the signal input terminal of the selection control circuit 1013 may be referred to as an enable signal.

During operation, the MCU may output the enable signal to the control signal input terminal of the selection control circuit 1013 through the control signal output interface IO2 to control the selection control circuit 1013 to switch between the temperature measurement mode and the encryption certification mode. For example, when the MCU sends the enable signal to the selection control circuit 1013, the selection control circuit 1013 may switch from the encryption certification mode to the temperature measurement mode. When the MCU stops sending the enable signal to the selection control circuit 1013, the selection control circuit 1013 may switch from the temperature measurement mode to the encryption certification mode.

The selection control circuit 1013 may include a pull-up circuit, a pull-down circuit, or any other suitable circuit. For example, in some embodiments, the selection control circuit 1013 may include two pull-up circuits. An end of each of the two pull-up circuits may be electrically connected to a pull-up power supply VDD, and the other end of each of the two pull-up circuits may be electrically connected to the communication cable 1015. The MCU may switch between the temperature measurement mode and the encryption certification mode by controlling on/off of the two pull-up circuits. For example, when one of the pull-up circuits becomes on and the other one of the pull-up circuits becomes off, the selection control circuit 1013 may switch from the encryption certification mode to the temperature measurement mode. Then, the controller 1011 may read the voltage of the temperature measurement resistor R1 of the battery 30 via the communication cable 1015 to obtain the inner temperature of the battery 30. When the on/off states of the two pull-up circuits are changed to the opposite of the above-described on/off states under the control of the controller 1011, the selection control circuit 1013 may switch from the temperature measurement mode to the encryption certification mode. As such, the controller 1011 may communicate with the encryption chip 301 of the battery 30 via the communication cable 1015 to determine whether the battery 30 is the certified battery 30.

In some embodiments, the communication cable 1015 may include any cable capable of transmitting an electrical signal. For example, in some embodiments, a multi-core cable may be used as the communication cable 1015 to facilitate the electrical connection between the communication cable 1015 and the MCU with the individually arranged communication interface IO1 and temperature measurement interface AD. As another example, in some other embodiments, a signal-core cable may be used as the communication cable 1015 to be electrically connected to the MCU with the communication interface IO1 and the temperature measurement interface AD integrated together. When the communication interface IO1 and the temperature measurement interface AD, which are configured to be electrically connected to the communication cable 1015, are individually provided at the MCU, the single-core cable may also be used to reduce the space occupied by the communication cable 1015. When the communication interface IO1 and the temperature measurement interface AD, which are configured to be electrically connected to the communication cable 1015, are integrated together at the MCU, the multi-core cable may also be used to improve signal transmission quality.

Referring again to FIG. 1, embodiments of the present disclosure further provide the battery 30 including a housing, one or more battery cells, the encryption chip 301, and the temperature measurement resistor R1. The battery cells, the encryption chip 301, and the temperature measurement resistor R1 are all arranged inside the housing. The battery cells are electrically connected to the encryption chip 301 to supply power to the encryption chip 301. The encryption chip 301 is also connected in parallel with the temperature measurement resistor R1 and is communicatively connected to the power supply management system 101 via a shared pin arranged at the housing, where the shared pin is shared by the encryption chip 301 and the temperature measurement resistor R1. Thereby, the power supply management system 101 may sense and measure the voltage of the temperature measurement resistor R1 and communicate with the encryption chip 301 via the communication cable 1015. In some embodiments, the battery 30 further includes a capacity Cl. The capacity Cl is connected in parallel with both the encryption chip 301 and the temperature measurement resistor R1 to protect the encryption chip 301, the resistor, the battery cells, and one or more of the other electronic elements of the battery 30.

During operation, the shared pin of the encryption chip 301 and the temperature measurement resistor R1 of the battery 30 may be electrically connected to the communication cable 1015 of the power supply management system 101. As such, the controller 1011 may control the selection control circuit 1013 to switch between the temperature measurement mode and the encryption certification mode to provide the voltage of the temperature measurement resistor R1 to the temperature measurement interface AD of the controller 1011 via the communication cable 1015 electrically connected to the shared pin and provide a communication channel for the encryption chip 301 of the battery 30 and the communication interface IO1 of the controller 1011 via the communication cable 1015 electrically connected to the shared pin. In some embodiments, the communication between the encryption chip 301 and the controller 1011 via the communication cable 1015 may be unidirectional or bidirectional. For example, in some embodiments, only the encryption chip 301 may send a signal to the controller 1011 via the communication cable 1015. In some other embodiments, both the encryption chip 301 and the controller 1011 may send signals to each other via the communication cable 1015.

In some embodiments, after the shared pin of the encryption chip 301 and the temperature measurement resistor R1 of the battery 30 is electrically connected to the communication cable 1015 of the power supply management system 101, the controller 1011 may send the control signal (e.g., the control signal output interface IO2 of the MCU may send the high-level or low-level signal) to control the selection control circuit 1013 to switch from the temperature measurement mode to the encryption certification mode. As such, the encryption chip 301 of the battery 30 may communicate with the controller 1011 via the communication cable 1015 of the power supply management system 101. For example, after the battery 30 is electrically connected to the power supply management system 101 via the communication cable 1015, the encryption chip 301 of the battery 30 may proactively or under the request of the controller 1011 send a certification code of the battery 30 to the controller 1011, or may send one or more other parameters simultaneously (e.g., model number, rated power, current remaining power, rated charging voltage, rated discharge voltage, etc. of the battery 30). As such, the controller 1011 may determine whether the battery 30 currently connected to the power supply management system 101 is the certified battery 30 (e.g., the acceptable battery 30) according to the received certification code. The controller 1011 may further control a charging/discharging process of the battery 30 according to the received parameters of the battery 30 to use the power of the battery 30 as much as possible. The controller 1011 of the power supply management system 101 may receive all of the certification code and other parameter information at one time or receive the certification code and other parameter information multiple times. Correspondingly, the battery 30 may also send the certification code and other parameter information at one time or multiple times.

The power supply management system 101 consistent with embodiments of the present disclosure may set the controller 1011 and the selection control circuit 1013, which may be controlled by the controller 1011 to switch between the temperature measurement mode and the encryption certification mode. Thus, the power supply management system 101 may use a signal communication cable 1015 to communicate with the battery 30 and may use the controller 1011 to control the selection circuit 1013 to realize the functions of the temperature measurement and encryption certification as needed. Based on the above, the battery 30 suitable for the power supply management system 101 consistent with embodiments of the present disclosure may only need to have the shared pin for the encryption chip 301 and the temperature measurement resistor R1 to be connected to the communication cable 1015 of the power supply management system 101. As such, the number of the components inside the battery 30 may be reduced, which is beneficial for a miniaturization and lightweight design of the battery 30.

In some embodiments, the encryption chip 301 and the temperature measurement resistor R1 of the battery 30 consistent with embodiments of the present disclosure may have the shared pin. The shared pin may be electrically connected to the controller 1011 of the power supply management system 101 via the single communication cable 1015. As such, under the control of the controller 1011, the selection control circuit 1013 of the power supply management system 101 may switch between the temperature measurement mode and the encryption certification mode to cause the controller 1011 to read the voltage of the temperature measurement resistor R1 and communicate with the encryption chip 301 via the shared pin. According to the above, the battery 30 of embodiments of the present disclosure may communicate with the controller 1011 of the power supply management system 101 via the single communication cable 1015 of the power supply management system 101 by providing the shared pin for the encryption chip 301 and the temperature measurement resistor R1. As such, the number of pins of the battery 30 to the outside may be reduced, which is beneficial for the miniaturization and lightweight design of the battery 30.

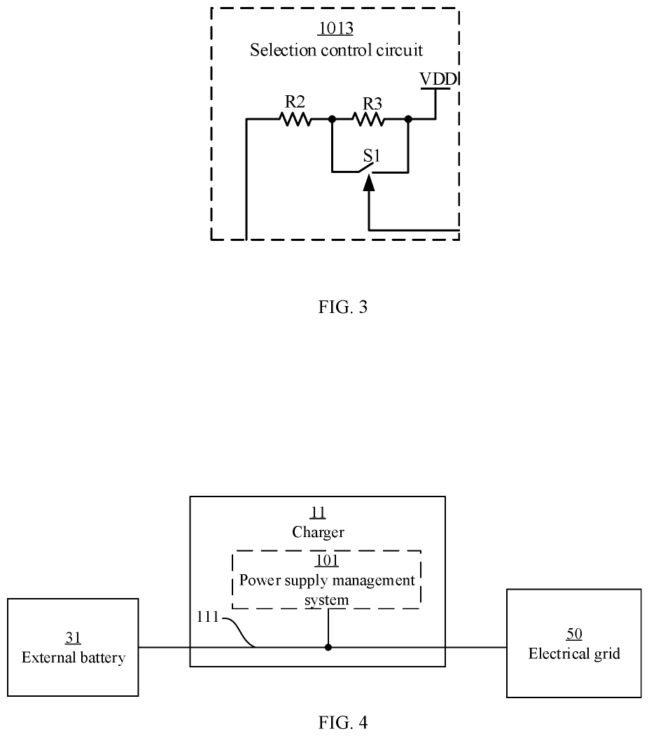

FIG. 2 and FIG. 3 show two types of selection control circuits according to embodiments of the present disclosure. As shown in FIG. 2 and FIG. 3, in some embodiments, the selection control circuit 1013 includes a pull-up resistor and a switch. An input end of the pull-up resistor is electrically connected to the pull-up power supply VDD. An output end of the pull-up resistor is electrically connected to the communication cable 1015. The control signal input terminal of the switch is electrically connected to the control signal output terminal of the controller 1011. The output terminal is electrically connected to the pull-up resistor. The switch may include at least one of a diode, a triode, or a field-effect transistor. In the examples shown in FIG. 2 and FIG. 3, a metal-oxide-semiconductor field-effect transistor (MOSFET) S1 is used as the switch. However, in some other embodiments, a single diode, triode, or other field-effect transistor may be selected as the switch according to the actual needs, or same or different switch components may be selected and connected in series or parallel to form a switch circuit as the switch according to the actual needs.

During operation, the switch may selectively change the resistance value of the pull-up resistor according to the control signal output by the controller 1011 to cause the selection control circuit 1013 to switch between the temperature measurement mode and the encryption certification mode. In some embodiments, the controller 1011 may output the control signal to the switch to cause the resistance value of the pull-up resistor to change between a first resistance value and a second resistance value under the operation of the switch. Thereby, the voltage of the temperature measurement resistor R1 of the battery 30 may change. Since the temperature measurement resistor R1 may have two different voltages under the control of the selection control circuit 1013, when the voltage of the temperature measurement resistor R1 is a certain value or in a certain value range, the controller 1011 may be activated to communicate with the encryption chip 301 via the communication interface IO1 or read the voltage of the temperature measurement resistor R1 via the temperature measurement interface AD to obtain the inner temperature of the battery 30. Since the circuit is pre-designed, when the selection control circuit 1013 is in the temperature measurement mode or the encryption certification mode, the voltage of the temperature measurement resistor R1 of the battery 30 may be determined. Therefore, when the controller 1011 controls the operation state of the switch to cause the selection control circuit 1013 to enter the temperature measurement mode or the encryption certification mode, the required control signal may be determined. Thus, when the controller 1011 sends a switch signal, the temperature measurement interface AD or communication interface IO1 corresponding to the switch signal may be directly activated.

For example, when the controller 1011 sends the control signal to cause the selection control circuit 1013 to enter the encryption certification mode from the temperature measurement mode, the controller 1011 may send a control signal to activate the communication interface IO1 simultaneously to cause the encryption chip 301 to communicate with the controller 1011. Similarly, when the controller 1011 sends the signal to cause the selection control circuit 1013 to enter the temperature measurement mode from the encryption certification mode, the controller 1011 may send a control signal to activate the temperature measurement interface AD simultaneously to read the voltage of the temperature measurement resistor R1 of the battery 30. Thus, the controller 1011 may calculate the temperature (e.g., the inner temperature of the battery 30) of the temperature measurement resistor R1 according to the characteristics of a temperature-sensitive resistor.

Referring to FIG. 2, in some embodiments, the pull-up resistor includes a first pull-up resistor (also referred to as a “first pull-up resistor component”) R2 and a second pull-up resistor (also referred to as a “second pull-up resistor component”) R3. The switch (e.g., MOSFET S1 in FIG. 2) and the second pull-up resistor R3 are connected in series first and then are connected to the first pull-up resistor R2 in parallel. The control signal input by the controller 1011 may be used to control the on/off of the MOSFET S1. Thus, when the MOSFET S1 is on, the resistance value after the first pull-up resistor R2 and the second pull-up resistor R3 are connected in parallel is a resistance value of the pull-up resistor. When the MOSFET S1 is off, the resistance value of the first pull-up resistor R2 alone is used as a resistance value of the pull-up resistor.

In some embodiments, when the resistance value of the pull-up resistor is equal to the resistance value of the first pull-up resistor R2, that is, the MOSFET S1 is off, the selection control circuit 1013 may be in the temperature measurement mode. In this case, the temperature measurement interface AD of the controller 1011 may read the voltage of the temperature measurement resistor R1 via the communication cable 1015 to calculate the inner temperature of the battery 30. Correspondingly, when the resistance value of the pull-up resistor is equal to the resistance value after the first pull-up resistor R2 and the second pull-up resistor R3 are connected in parallel, that is, the MOSFET S1 is on, the selection control circuit 1013 may be in the encryption certification mode. In this case, the communication interface IO1 of the controller 1011 may communicate with the encryption chip 301 via the communication cable 1015.

Referring to FIG. 3, in some other embodiments, the pull-up resistor also includes the first pull-up resistor R2 and the second pull-up resistor R3. The switch (e.g., MOSFET S1 in FIG. 3) and the second pull-up resistor R3 are connected in parallel first, then are connected to the first pull-up resistor R2 in series. The control signal input by the controller 1011 may be used to control the on/off of the MOSFET S1. Thus, when the MOSFET S1 is off, the resistance value after the first pull-up resistor R2 and the second pull-up resistor R3 are connected in series is a resistance value of the pull-up resistor. When the MOSFET S1 is on, the resistance value of the first pull-up resistor R2 alone may be used as a resistance value of the pull-up resistor.

In some embodiments, when the resistance value of the pull-up resistor is equal to the sum of the resistance values of the first pull-up resistor R2 and the second pull-up resistor R3, that is, the MOSFET S1 is off, the selection control circuit 1013 may be in the temperature measurement mode. In this case, the temperature measurement interface AD of the controller 1011 may read the voltage of the temperature measurement resistor R1 via the communication cable 1015 to calculate the inner temperature of the battery 30. Correspondingly, when the resistance value of the pull-up resistor is equal to the resistance value of the first pull-up resistor R2, that is, the MOSFET S1 is on, the selection control circuit 1013 may be in the encryption certification mode. In this case, the communication interface IO1 of the controller 1011 may communicate with the encryption chip 301 via the communication cable 1015.

Although a single MOSFET S1 is used in the two examples of the selection control circuit 1013 shown in FIG. 2 and FIG. 3, those skilled in the art should know that the MOSFET S1 may be replaced by at least one of diode, triode, or other field-effect transistor.

Further, to continuously obtain the parameters and temperature of the battery 30 during practical operation, in some embodiments, the controller 1011 may selectively output the control signal to the selection control circuit 1013 (e.g., the switch) periodically. As such, the selection control circuit 1013 may cycle periodically between the temperature measurement mode and the encryption certification mode. For example, the controller 1001 may include a cycle of several seconds, tens of seconds, several minutes, or any other time. In the cycle, the controller 1001 may control the selection control circuit 1013 to measure and determine the inner temperature of the battery 30 once and communicate with the encryption chip 301 once. In one cycle, the time that the controller 1011 measures and determines the inner temperature of the battery 30 may be the same as or different from the time that the controller 1011 communicates with the encryption chip 301, which may be set according to the actual needs.

The communication cable 1015 may further be configured to supply power to the encryption chip 301. Thus, the wiring configured to supply the power from the battery cells to the encryption chip 301 in the battery 30 may be removed to reduce the complexity of the wiring in the battery 30. Thereby, the weight and volume of the battery 30 may be further reduced.

FIG. 4 is a schematic circuit diagram showing a charger 11 being used to charge an external battery 31. As shown in FIG. 4, embodiments of the present disclosure further provide the charger 11. The charger includes a charging circuit 111 and the power supply management system 101. The power supply management system 101 is described above and is electrically connected to the charging circuit 111. The power supply management system 101 may be configured to control the charging circuit 111 to charge the external battery 31. In some embodiments, the charging circuit 111 may include any suitable charging circuit, which is not described in detail here.

During operation, when the external battery 31 is electrically connected to electrical grid 50 through the charger 11, the controller 1011 of the power supply management system 101 may control the selection control circuit 1013 to switch to the encryption certification mode to perform certification on the external battery 31 to determine whether the external battery 31 is the certified battery 30. When the controller 1011 determines that the external battery 31 is the certified battery 30, the controller 1011 may cause the charging circuit 111 to turn on to charge the external battery 31 by the electrical grid 50. When the controller 1011 determines that the external battery 31 is not the certified battery 30, the controller 1011 may not cause the charging circuit 111 to turn on, thus, the external battery 31 may not be charged through the charger 11.

In some embodiments, the power supply management system 101 and the charging circuit 111 may be integrated together to miniaturize the charger 11.

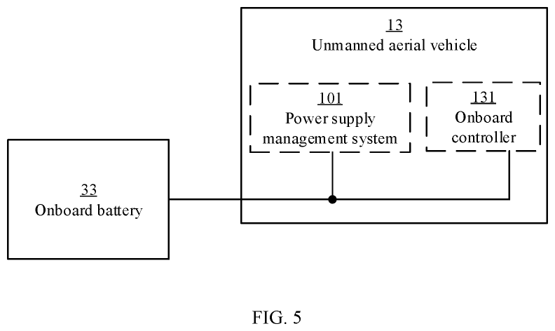

FIG. 5 is a schematic circuit diagram of an unmanned aerial vehicle (UAV) 13 and a onboard battery 33 of the UAV 13. As shown in FIG. 5, the UAV 13 consistent with embodiments of the present disclosure includes an onboard controller 131 and the power supply management system 101. The power supply management system 101 can be the power supply management system 101 described above. The onboard controller 131 may include at least one of a gimbal controller or a flight controller, and can be the controller 1011 described above. In some embodiments, the onboard controller 131 and the power supply management system 101 may be integrated together to reduce the volume of the UAV 13 to achieve the miniaturization of the UAV 13.

When the UAV 13 starts to operate or the onboard battery 33 is installed at the UAV 13, the controller 1011 of the power supply management system 101 of the UAV 13 may control the selection control circuit 1013 to switch to the encryption certification mode to communicate with the encryption chip 301 of the onboard battery 33. As such, the controller 1011 may determine whether the onboard battery 33 is the certified battery 30 which is allowed to be installed at the UAV 13. When the power supply management system 101 determines that the onboard battery 33 installed at the UAV 13 is the certified battery 30, the power supply management system 101 may electrically connect the onboard battery 33 to the onboard controller 131 to supply power to the onboard controller 131 through the onboard battery 33. Therefore, the onboard controller 131 may normally control the flight of the UAV 13 or control the gimbal to operate. When the power supply management system 101 determines that the onboard battery 33 is an illegal battery 30 without certification, the power supply management system 101 may control the onboard battery 33 not to supply power to the onboard controller 131 to protect the onboard controller 131.

Although the advantages associated with certain embodiments of the present disclosure have been described in the context of embodiments, other embodiments may also include such advantages, and not all embodiments describe all the advantages of the present disclosure in detail. The advantages objectively brought by the technical features of embodiments should be regarded as the advantages of the present disclosure which are different from the prior art, and all belong to the scope of the present disclosure.

What is claimed is:

1. A power supply management system comprising:
a selection control circuit;
a controller connected to the selection control circuit and configured to control the selection control circuit to switch between a temperature measurement mode and an encryption certification mode; and
a communication cable, one end of the communication cable being configured to be communicatively connected to a battery, and another end of the communication cable being electrically connected to a communication interface and a temperature measurement interface of the controller;
wherein the controller is configured to:
in response to the selection control circuit switching to the temperature measurement mode, read a voltage of a temperature measurement resistor of the battery via the communication cable; and
in response to the selection control circuit switching to the encryption certification mode, communicate with an encryption chip of the battery via the communication cable.

2. The system of claim 1, wherein the selection control circuit includes:
a pull-up resistor connected to the communication cable; and
a switch configured to selectively change a resistance value of the pull-up resistor to cause the selection control circuit to switch between the temperature measurement mode and the encryption certification mode.

3. The system of claim 2, wherein:
the pull-up resistor includes a first pull-up resistor component and a second pull-up resistor component;
the switch and the second pull-up resistor component are connected in series to form a series circuit; and
the series circuit is connected with the first pull-up resistor component in parallel.

4. The system of claim 2, wherein:
the pull-up resistor includes a first pull-up resistor component and a second pull-up resistor component;
the switch and the second pull-up resistor component are connected in parallel to form a parallel circuit; and
the parallel circuit is connected to the first pull-up resistor component in series.

5. The system of claim 2, wherein the switch includes at least one of a diode, a triode, or a field-effect transistor.

6. The system of claim 5, wherein the switch includes a metal-oxide-semiconductor field-effect transistor (MOSFET).

7. The system of claim 2, wherein a control signal input terminal of the switch is configured to be connected to a control signal output interface of the controller.

8. The system of claim 1, wherein the controller is further configured to output a periodical signal to control the selection control circuit to cycle periodically between the temperature measurement mode and the encryption certification mode.

9. The system of claim 1, wherein the communication cable is further configured to supply power to the encryption chip.

10. The system of claim 1, wherein the temperature measurement interface and the communication interface are integrated as a shared interface.

11. An unmanned aerial vehicle (UAV) comprising:
an onboard controller; and
a power supply management system including:
a selection control circuit;
a controller connected to the selection control circuit and configured to control the selection control circuit to switch between a temperature measurement mode and an encryption certification mode; and
a communication cable, one end of the communication cable being configured to be communicatively connected to a battery, and another end of the communication cable being electrically connected to a communication interface and a temperature measurement interface of the controller;
wherein the controller is configured to:
in response to the selection control circuit switching to the temperature measurement mode, read a voltage of a temperature measurement resistor of the battery via the communication cable; and
in response to the selection control circuit switching to the encryption certification mode, communicate with an encryption chip of the battery via the communication cable.

12. The UAV of claim 11, wherein the selection control circuit includes:
a pull-up resistor connected to the communication cable; and
a switch configured to selectively change a resistance value of the pull-up resistor to cause the selection control circuit to switch between the temperature measurement mode and the encryption certification mode.

13. The UAV of claim 12, wherein:
the pull-up resistor includes a first pull-up resistor component and a second pull-up resistor component;
the switch and the second pull-up resistor component are connected in series to form a series circuit; and
the series circuit is connected with the first pull-up resistor component in parallel.

14. The UAV of claim 12, wherein:
the pull-up resistor includes a first pull-up resistor component and a second pull-up resistor component;
the switch and the second pull-up resistor component are connected in parallel to form a parallel circuit; and
the parallel circuit is connected to the first pull-up resistor component in series.

15. The UAV of claim 12, wherein the switch includes at least one of a diode, a triode, or a field-effect transistor.

16. The UAV of claim 15, wherein the switch includes a metal-oxide-semiconductor field-effect transistor (MOSFET).

17. The UAV of claim 12, wherein a control signal input terminal of the switch is configured to be connected to a control signal output interface of the controller.

18. The UAV of claim 11, wherein the controller is further configured to output a periodical signal to control the selection control circuit to cycle periodically between the temperature measurement mode and the encryption certification mode.

19. The UAV of claim 11, wherein the communication cable is further configured to supply power to the encryption chip.

20. The UAV of claim 11, wherein the temperature measurement interface and the communication interface are integrated as a shared interface.
